(19) United States
(12) Patent Application Publication
(10) Pub. No.: US 2026/0100756 A1
(43) Pub. Date: Apr. 9, 2026

(54) ADAPTIVE SATELLITE ROUTING ORCHESTRATION SYSTEM, METHOD AND COMPUTER-READABLE MEDIUM THEREOF

(71) Applicant: CHUNGHWA TELECOM CO., LTD., Taoyuan City (TW)

(72) Inventors: Po-Yen Chang, Taoyuan City (TW); Chia-Horng Liu, Taoyuan City (TW)

(21) Appl. No.: 19/060,912

(22) Filed: Feb. 24, 2025

(30) Foreign Application Priority Data
Oct. 4, 2024 (TW) 113137956

(51) Int. Cl. H04B 7/185; H04L 45/302

(52) U.S. Cl. CPC H04B 7/18584; H04L 45/302

(57) ABSTRACT

An adaptive satellite routing orchestration system and an adaptive satellite routing orchestration method are provided. Under the low earth orbit satellite network architecture, by the determination of the connection status of the external submarine cable at the location where the ground network access point and the mobile core network are connected to the mobile network, the traffic of the mobile network is guided to the mobile core network via the submarine cable or the traffic of the mobile network is guided to the mobile core network via the low earth orbit satellite network. A computer-readable medium for executing the adaptive satellite routing orchestration method is further provided.

### CROSS-REFERENCE TO RELATED APPLICATION

This application claims the benefit of Taiwan Patent Application Serial No. 113137956 filed on October 4, 2024. The entirety of each Application is incorporated herein by reference.

### BACKGROUND

### 1. Technical Field

The present disclosure relates to network transmission technology, and more particularly, to an adaptive satellite routing orchestration system, method and a computer-readable medium thereof.

### 2. Description of the Prior Art

Submarine cables (undersea cables) are installed on the seabed and are used to provide telecommunications or power transmission between different regions. Via submarine cables (undersea cables), communication messages can be transmitted between two ends in different areas. In the era of network communication, information communication services required for daily life or business transactions will be provided. Therefore, submarine cables (undersea cables) play a crucial role in current network services.

Taiwan has an island-type terrain. When a large-scale disaster or war occurs, it may affect the Internet services of critical mobile network infrastructures. In other words, if there is an abnormality in the submarine cable (undersea cable), Taiwan will not be able to exchange traffic with other countries, which will cause great disorder to daily users, companies, or government agencies. Therefore, under the current high demand for telecommunications networks, it has become very important to maintain mobile network services and maintain operations when the mobile network is affected.

Therefore, how to find a network transmission technology, especially the normal transmission of traffic that can still be continued when the submarine cable (undersea cable) is abnormal or disconnected, will become a goal that persons skilled in the art are eager to pursue.

### SUMMARY

In order to achieve the above-mentioned purposes, the present disclosure provides an adaptive satellite routing orchestration system, which comprises: a packet analysis module configured for receiving traffic from a low earth orbit satellite network system to analyze the traffic to generate a traffic source of the traffic; a routing switch control module connected to a submarine cable (undersea cable) switch and configured for obtaining a submarine cable (undersea cable) connection status from the submarine cable (undersea cable) switch; and a routing priority control module connected to the packet analysis module and the routing switch control module, and configured for generating a routing switch decision based on a routing priority when the traffic source is a mobile network, wherein a routing switch decision result and a routing switch command are generated based on the routing switch decision, and the routing switch decision result and the routing switch command are transmitted to the packet analysis module and the routing switch control module respectively, wherein the packet analysis module sends the traffic to the routing switch control module according to the routing switch decision result, so that the routing switch control module switches a traffic routing path according to the routing switch command to guide the traffic to enter a mobile core network via a submarine cable (undersea cable) or the low earth orbit satellite network system.

In one embodiment, the packet analysis module directly transmits the traffic to the routing switch control module to guide the traffic into the Internet when the packet analysis module analyzes and determines that the traffic source of the traffic is a wireless local area network (Wi-Fi).

In one embodiment, the routing priority is generated by the routing priority control module based on the submarine cable (undersea cable) connection status obtained by the routing switch control module, wherein the routing priority includes transmission via the submarine cable (undersea cable) and transmission via the low earth orbit satellite network system.

In one embodiment, a virtual channel established by a source end of the traffic is deactivated when the packet analysis module analyzes and determines that the traffic source is a mobile network.

In one embodiment, when the traffic enters the mobile core network via the low earth orbit satellite network system, a new virtual channel is first established by the packet analysis module and guided to a private network, so that the routing switch control module guides the traffic to a low earth orbit satellite access point of the low earth orbit satellite network system via the new virtual channel, and after the traffic is transmitted to a low earth orbit satellite ground terminal of the low earth orbit satellite network system via the low earth orbit satellite network, the new virtual channel is deactivated, and finally the traffic enters the mobile core network.

The present disclosure further discloses an adaptive satellite routing orchestration method, the adaptive satellite routing orchestration method is executed in a computer or a server and comprises the following steps: receiving, by a packet analysis module, traffic from a low earth orbit satellite network system to analyze the traffic to generate a traffic source of the traffic; obtaining, by a routing switch control module, a submarine cable (undersea cable) connection status from a submarine cable (undersea cable) switch; generating, by a routing priority control module, a routing switch decision based on a routing priority when the traffic source is a mobile network, wherein a routing switch decision result and a routing switch command are generated based on the routing switch decision, and the routing switch decision result and the routing switch command are transmitted to the packet analysis module and the routing switch control module respectively; and sending, by the packet analysis module, the traffic to the routing switch control module according to the routing switch decision result, so that the routing switch control module switches a traffic routing path according to the routing switch command to guide the traffic to enter a mobile core network via a submarine cable (undersea cable) or the low earth orbit satellite network system.

In the above-mentioned method, the packet analysis module directly transmits the traffic to the routing switch control module to guide the traffic into the Internet when the packet analysis module analyzes and determines that the traffic source of the traffic is a wireless local area network (Wi-Fi).

In the above-mentioned method, the routing priority is generated by the routing priority control module based on the submarine cable (undersea cable) connection status obtained by the routing switch control module, wherein the routing priority includes transmission via the submarine cable (undersea cable) and transmission via the low earth orbit satellite network system.

In the above-mentioned method, a virtual channel established by a source end of the traffic is deactivated when the packet analysis module analyzes and determines that the traffic source is a mobile network.

In the above-mentioned method, the step of the routing switch control module guiding the traffic to the mobile core network via the low earth orbit satellite network system comprises: a new virtual channel is first established by the packet analysis module and guided to a private network, so that the routing switch control module guides the traffic to a low earth orbit satellite access point of the low earth orbit satellite network system via the new virtual channel, and after the traffic is transmitted to a low earth orbit satellite ground terminal of the low earth orbit satellite network system via the low earth orbit satellite network, the new virtual channel is deactivated, and finally the traffic enters the mobile core network.

The present disclosure further discloses a computer-readable medium, used in a computing device or a computer, which stores instructions to execute the above-mentioned adaptive satellite routing orchestration method.

In summary, the adaptive satellite routing orchestration system, method and computer-readable medium of the present disclosure are applied to communication networks. The present disclosure mainly provides an adaptive dynamic route switching and has backup mechanism. Through the design of low earth orbit satellite ground terminal route switching, the real-time operating status of submarine cables (undersea cables) can be detected, and adaptive dynamic route switching can be realized based on the detection results. Therefore, under the low earth orbit satellite network architecture, the traffic transmission of the low earth orbit satellite ground terminal can intelligently and dynamically switch the mobile backhaul routing (the mobile communication backhaul network routing) according to the connection status of the external submarine cable (undersea cable), so that the traffic can be delivered to the mobile core network of the back-end, such that the mobile communication network can continue to operate normally on different routes.

### BRIEF DESCRIPTION OF THE DRAWINGS

FIG. 1 is a system architecture diagram of an adaptive satellite routing orchestration system according to the present disclosure.

FIG. 2A to FIG. 2C are schematic diagrams of individual path routing in different states of the adaptive satellite routing orchestration system according to the present disclosure.

FIG. 3 is a step diagram of an adaptive satellite routing orchestration method according to the present disclosure.

FIG. 4 is an operation flowchart of the adaptive satellite routing orchestration method according to the present disclosure.

FIG. 5 is a time sequence diagram of Wi-Fi traffic signaling exchange according to the present disclosure.

FIG. 6 is a time sequence diagram of the present disclosure regarding the exchange of the traffic signaling of the mobile network via a submarine cable (undersea cable).

FIG. 7 is a time sequence diagram of the present disclosure regarding the exchange of the traffic signaling of the mobile network via a low earth orbit satellite network system.

### DETAILED DESCRIPTION

The following illustrative embodiments are provided to illustrate the present disclosure, these and other advantages and effects can be apparently understood by those in the art after reading the disclosure of this specification. However, the present disclosure can also be implemented or applied through other different specific implementation forms.

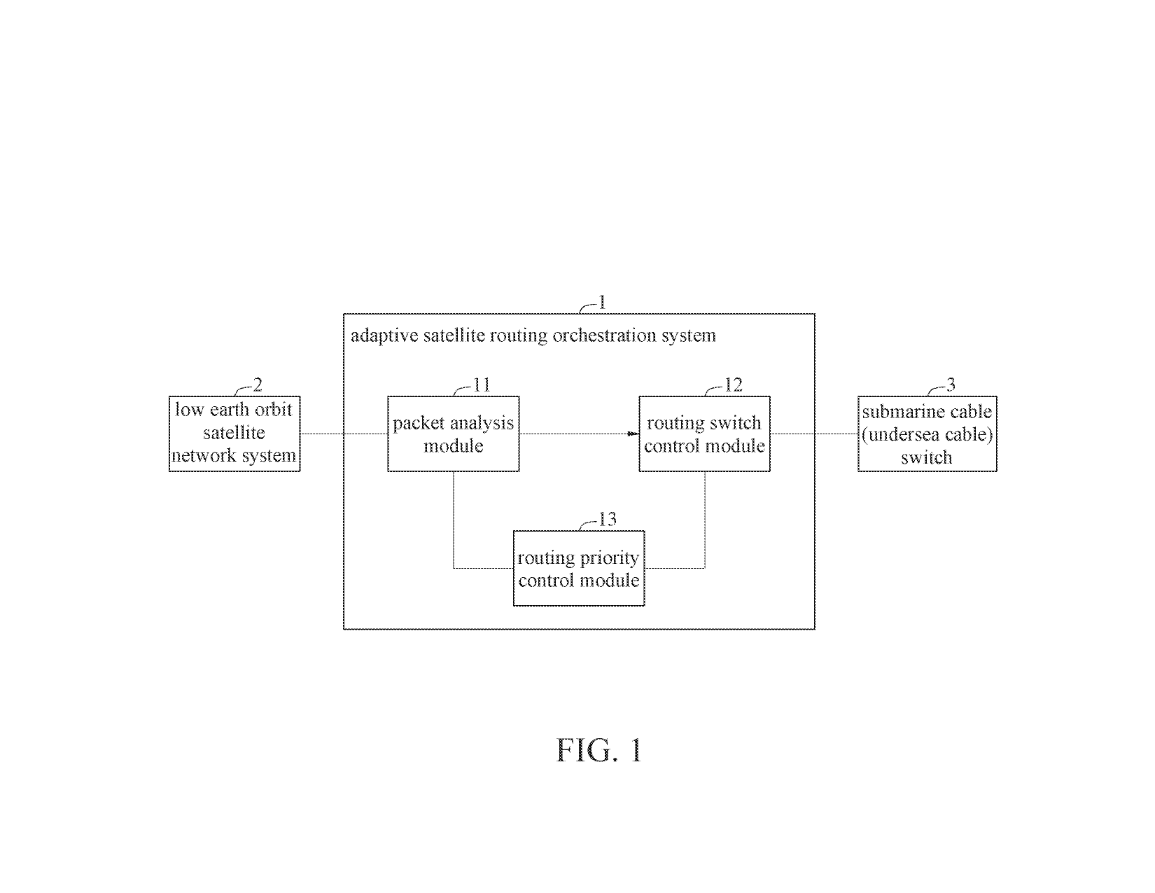

FIG. 1 is a system architecture diagram of an adaptive satellite routing orchestration system according to the present disclosure. As shown in the figure, in one embodiment, the application scenario is to evaluate the feedback information of the connection status of the submarine cable (undersea cable) under the low earth orbit (LEO) satellite network architecture. Therefore, the system can adaptively and dynamically switch traffic routing paths so that traffic can be guided back to the back-end mobile core network, wherein an adaptive satellite routing orchestration system 1 can be installed at a ground network access point (point of presence [PoP]), that is, the access point where the traffic is connected to the ground network via a low earth orbit satellite network system 2, wherein the adaptive satellite routing orchestration system 1 includes a packet analysis module 11, a routing switch control module 12 and a routing priority control module 13.

The packet analysis module 11 is used to receive the traffic from the low earth orbit satellite network system 2 and analyze the traffic to generate the traffic source of the traffic. In other words, the packet analysis module 11 can analyze the received traffic packets to confirm the source of the traffic, so as to provide different transmission methods according to different types. For example, if the traffic source is a wireless local area network (Wi-Fi), the traffic can be directly guided to the Internet (i.e., the public network), and if the traffic source is a mobile network, since the traffic is transmitted via the base station (the traffic also needs to be registered first), the traffic must be confirmed by the mobile core network before it can access the Internet. Therefore, the packet analysis module 11 needs to confirm the traffic source.

The routing switch control module 12 is connected to a submarine cable (undersea cable) switch 3, and is used to obtain the connection status of the submarine cable (undersea cable) from the submarine cable (undersea cable) switch 3. In other words, when accessing the core network of the ground network, the submarine cable (undersea cable) is used for transmission. Therefore, if the submarine cable (undersea cable) is abnormal or disconnected, normal communication will not be continued. Therefore, the routing switch control module 12 will obtain the connection status of the submarine cable (undersea cable) from the submarine cable (undersea cable) switch 3 (the submarine cable (undersea cable) switch 3 is connected to the submarine cable (undersea cable)), which will serve as a basis for subsequent traffic transmission.

The routing priority control module 13 is connected to the packet analysis module 11 and the routing switch control module 12. When the traffic source is a mobile network, the routing priority control module 13 will generate a routing switch decision based on the route priority, and generate a routing switch decision result and a routing switch command based on the routing switch decision, so as to respectively send the routing switch decision result and the routing switch command to the packet analysis module 11 and the routing switch control module 12, wherein the packet analysis module 11 transmits the traffic to the routing switch control module 12 according to the routing switch decision result, so that the routing switch control module 12 switches the traffic routing path according to the routing switch command to guide the traffic to enter the mobile core network via the submarine cable (undersea cable) or the low earth orbit satellite network system 2. In addition, the routing priority is generated by the routing priority control module 13 based on the connection status of the submarine cable (undersea cable) obtained by the routing switch control module 12, and the routing priority includes transmission via the submarine cable (undersea cable) and transmission via the low earth orbit satellite network system 2.

Specifically, the routing priority control module 13 can generate a routing switch decision based on the traffic source and submarine cable (undersea cable) status, and the routing switch decision will generate a routing switch decision result and a routing switch command, and send the routing switch decision result and the routing switch command to the packet analysis module 11 and the routing switch control module 12 respectively, so that the packet analysis module 11 knows how the traffic is to be delivered, and the routing switch control module 12 switches routes according to the method to be delivered, such as continuing to use the submarine cable (undersea cable) or switching to the low earth orbit satellite network system 2, so as to access the mobile core network of the ground network.

Specifically, when it is confirmed that the traffic source is the mobile network and the submarine cable (undersea cable) connection is normal, the traffic remains transmitted by the submarine cable (undersea cable). On the contrary, when it is confirmed that the traffic source is the mobile network but there is a problem with the submarine cable (undersea cable) connection, the routing switch control module 12 switches the route so that the traffic enters the low earth orbit satellite network system 2 for transmission.

In one embodiment, when the packet analysis module 11 analyzes and determines that the traffic source of the traffic is a wireless local area network, the traffic does not need to be transmitted via the submarine cable (undersea cable), so the transmission of the traffic is not affected by whether the submarine cable (undersea cable) is normal or not. At this time, the packet analysis module 11 directly transmits the traffic to the routing switch control module 12 to guide the traffic directly into the Internet.

In addition, when the packet analysis module 11 analyzes and determines that the traffic source is a mobile network, it means that the traffic will enter the mobile core network via the submarine cable (undersea cable) or the low earth orbit satellite network system 2. At this time, a virtual channel established by the source end of the traffic will not be applicable, so the packet analysis module 11 deactivates the virtual channel. In one embodiment, when transmitted over a virtual channel, traffic packets are encrypted to ensure transmission security. Therefore, if there is no need to transmit the traffic packets via the virtual channel, the traffic packets need to be decrypted. Therefore, the deactivation of the virtual channel described here includes the concept of decrypting the traffic packets.

In one embodiment, when the traffic enters the mobile core network via the low earth orbit satellite network system 2, a new virtual channel is first established by the packet analysis module 11 and guided to the private network, so that the routing switch control module 12 guides the traffic to the low earth orbit satellite access point of the low earth orbit satellite network system 2 via the new virtual channel. After the traffic is transmitted to the low earth orbit satellite ground terminal of the low earth orbit satellite network system 2 via the low earth orbit satellite network, the new virtual channel is deactivated, and the traffic finally enters the mobile core network. It can be seen from the above that when the adaptive satellite routing orchestration system 1 decides that the traffic should be redirected to the route of the low earth orbit satellite network system 2, it will guide the traffic back to the low earth orbit satellite network system 2 and establish a new virtual channel. Therefore, via the low earth orbit satellite network of the low earth orbit satellite network system 2, the traffic is sent to a low earth orbit satellite user terminal (LEO UT) that is preset and connected to the mobile core network.

In summary, in the design of switching traffic routing path based on the connection status of the submarine cable (undersea cable) according to the present disclosure, through the prepared signaling exchange before routing switch and the signaling exchange in the routing switch process, traffic can have different routing paths in different situations, wherein the routing path may include the path of transmitting the traffic via the submarine cable (undersea cable) to the mobile core network of the back-end, and the path of guiding the traffic back to the access point of the low earth orbit satellite network system 2 after route analysis by the adaptive satellite routing orchestration system 1 and the path of transmitting the traffic via the low earth orbit satellite network to the low earth orbit satellite ground terminal (where the low earth orbit satellite ground terminal is switched from the submarine cable (undersea cable)) for traffic reception and traffic transmission to the mobile core network of the back-end, thereby achieving backup purposes.

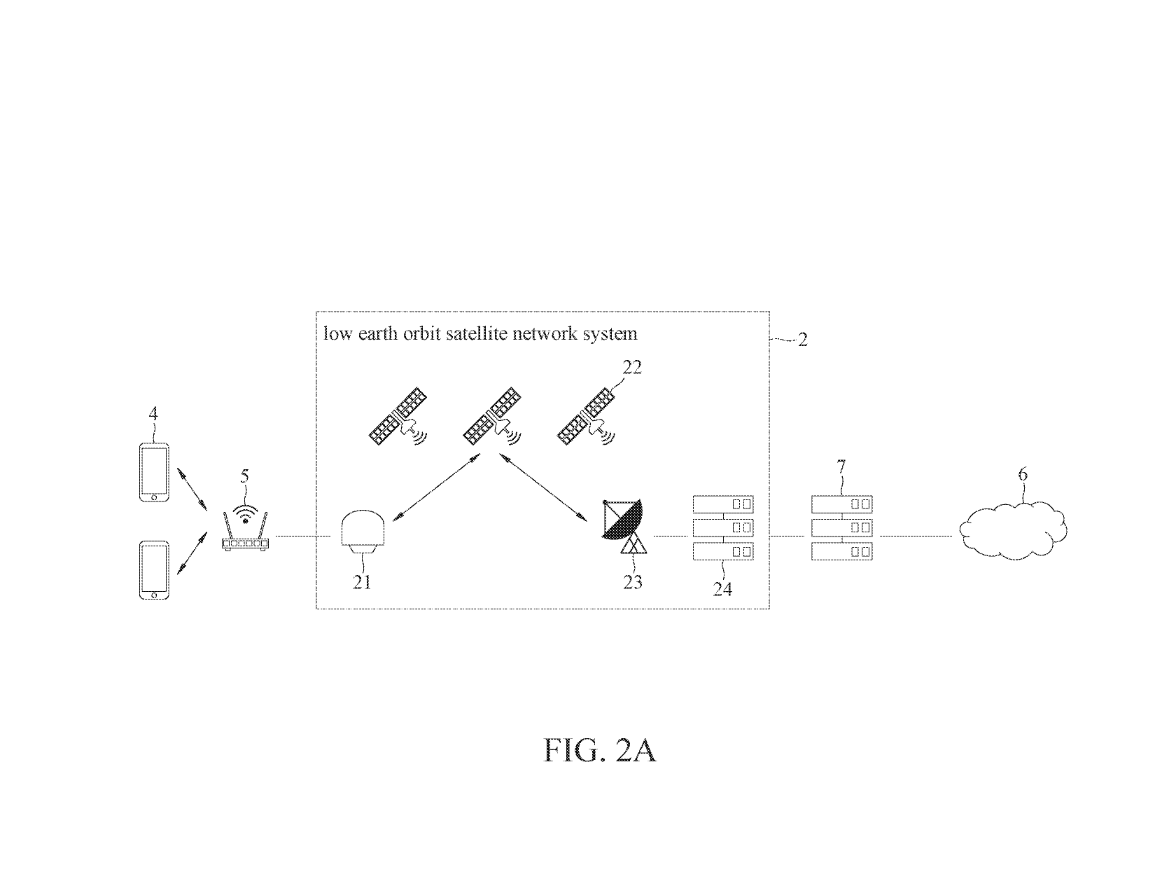

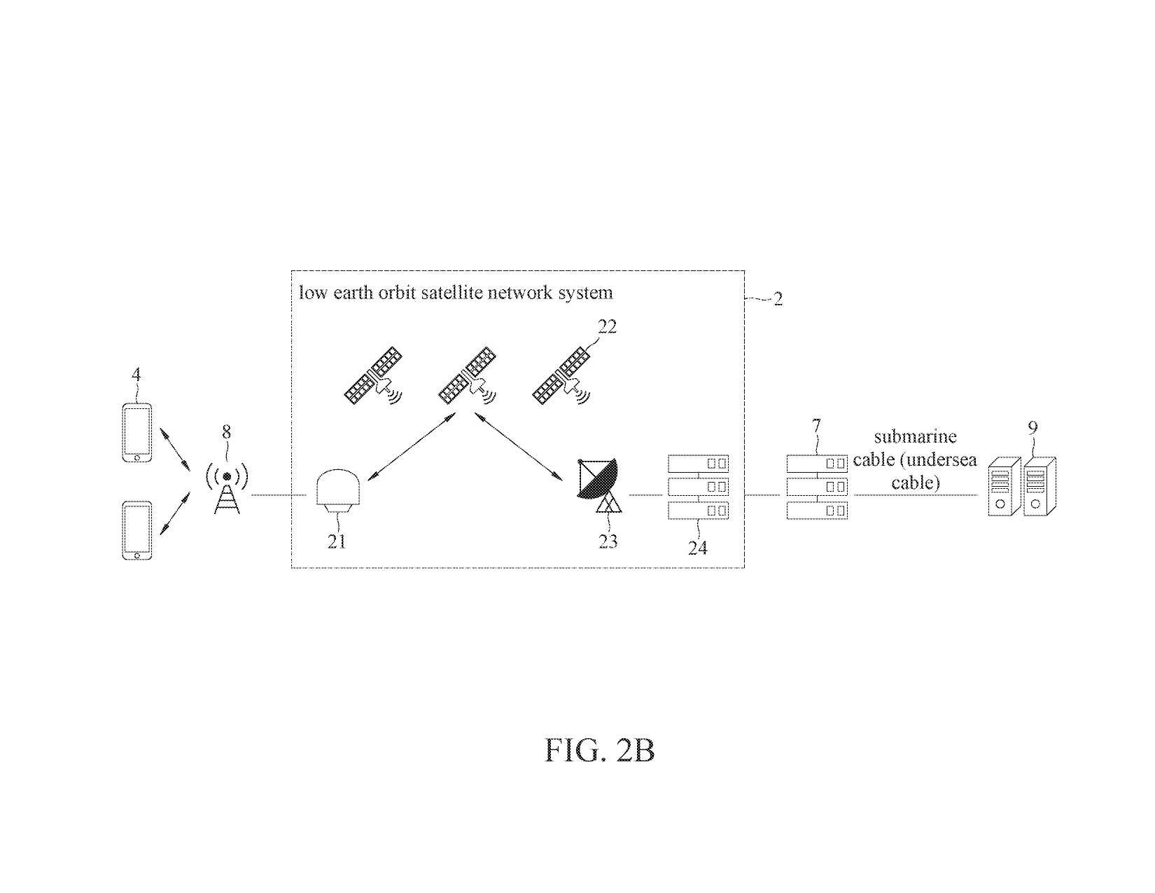

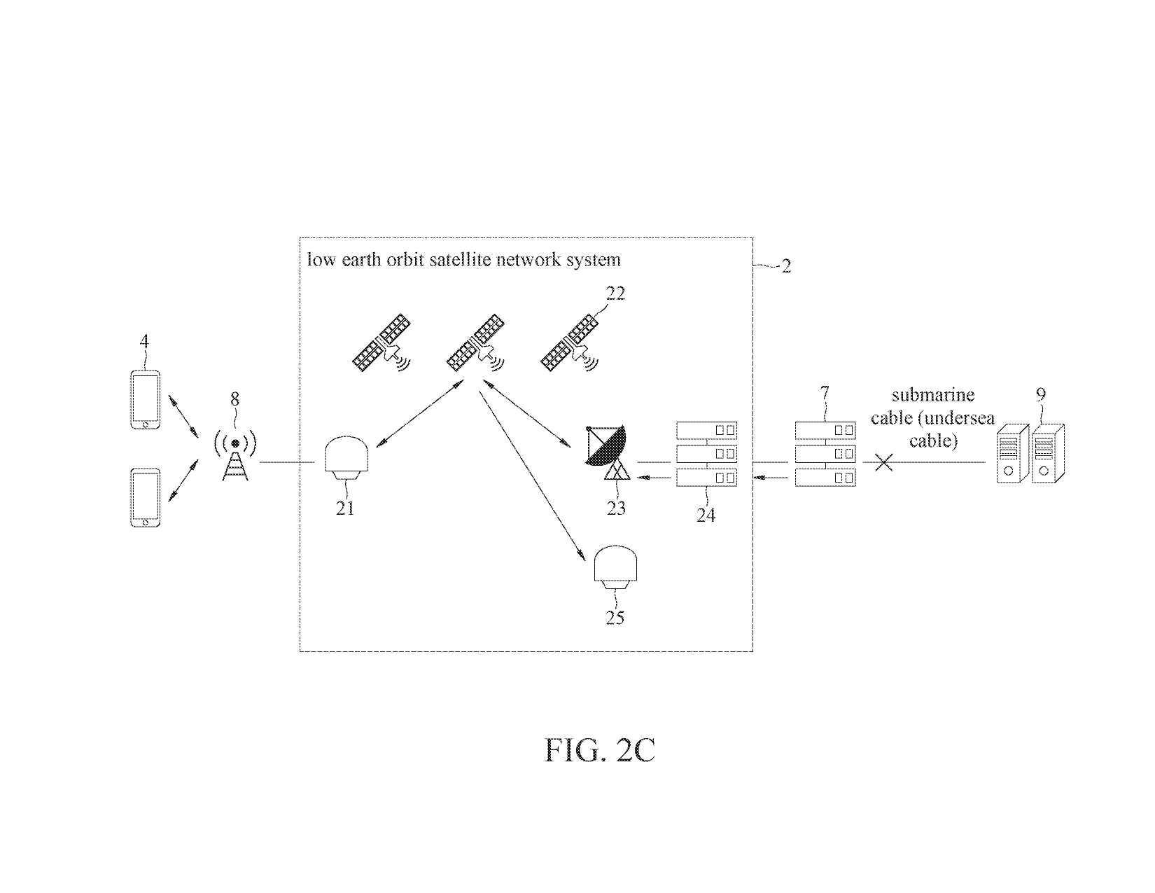

FIG. 2A to FIG. 2C are schematic diagrams of individual path routing in different states of the adaptive satellite routing orchestration system according to the present disclosure. The foregoing description shows that traffic will have different routing paths depending on the source and the connection status of the submarine cable (undersea cable). The three routing paths of traffic are further explained below.

First, the overall architecture is explained. As shown in FIG. 2B, the mobile backhaul routing (the mobile communication backhaul network routing) mainly includes a mobile communication base station 8, a low earth orbit satellite network system 2, ground network access points 7 and mobile core networks 9. In addition, the low earth orbit satellite network system 2 includes a low earth orbit satellite user terminal (UT) 21, low earth orbit satellites 22, a low earth orbit satellite network portal (SNP) 23 and low earth orbit satellite access points (PoP) 24. The adaptive satellite routing orchestration system of the present disclosure is configured in the ground network access point 7 and includes a packet analysis module, a routing switch control module and a routing priority control module.

The packet analysis module analyzes the source terminal information of incoming satellite traffic, establishes a virtual channel with high security requirements, and guides traffic routing. The routing priority control module can set the routing priority levels of different communication connections according to the feedback status of the submarine cable (undersea cable) to ensure the stability and efficiency of communication when switching routes. The routing switch control module is responsible for feeding back the status of the submarine cable (undersea cable) to the routing priority control module and for determining and switching the traffic routing paths according to the instructions of the routing priority control module. In this architecture, the routing switch control module can switch the traffic routing paths to the Internet, the submarine cables (undersea cables), or the low earth orbit satellite networks.

As shown in FIG. 2A, user terminal devices 4 transmit traffic via a wireless local area network access point (Wi-Fi AP) 5. The traffic passes through the low earth orbit satellite user terminal 21, the low earth orbit satellites 22, the low earth orbit satellite network portal 23 and the low earth orbit satellite access points 24, and then enters the ground network access points 7. The adaptive satellite routing orchestration system within the ground network access point 7 performs source analysis. When the adaptive satellite routing orchestration system determines that the source of the received terminal information traffic is a wireless local area network (Wi-Fi), the adaptive satellite routing orchestration system guides the traffic to the Internet 6. In this embodiment, because the traffic source is the wireless local area network, the transmission of the traffic is not affected by the connection status of the submarine cable (undersea cable).

As shown in FIG. 2B, the user terminal devices 4 transmit traffic via the mobile communication base station 8. The traffic passes through the low earth orbit satellite user terminal 21, the low earth orbit satellites 22, the low earth orbit satellite network portal 23 and the low earth orbit satellite access points 24, and then enters the ground network access points 7, wherein the ground network access points 7 are connected to the mobile core networks 9 via the submarine cable (undersea cable). After the traffic enters the ground network access points 7, the adaptive satellite routing orchestration system in the ground network access point 7 performs source analysis. When the adaptive satellite routing orchestration system determines that the source of the received terminal information traffic is the mobile network, it indicates that the traffic can be transmitted to the mobile core networks 9 via the submarine cable (undersea cable). At this time, when the adaptive satellite routing orchestration system receives that the connection status of the submarine cable (undersea cable) between the ground network access points 7 and the locations of the mobile core networks 9 of the back-end is normal, the adaptive satellite routing orchestration system will guide the traffic so as to transmit the traffic via the submarine cable (undersea cable) to the mobile core networks 9 of the back-end. In this embodiment, since the connection status of the submarine cable (undersea cable) is normal, the submarine cable (undersea cable) is continued to be used to transmit the traffic.

As shown in FIG. 2C, the user terminal devices 4 transmit traffic via the mobile communication base station 8. The traffic passes through the low earth orbit satellite user terminal 21, the low earth orbit satellites 22, the low earth orbit satellite network portal 23 and the low earth orbit satellite access points 24, and then enters the ground network access points 7. The adaptive satellite routing orchestration system within the ground network access point 7 performs source analysis. When the adaptive satellite routing orchestration system determines that the source of the received terminal information traffic is the mobile network, and the adaptive satellite routing orchestration system determines that the connection status of the submarine cable (undersea cable) between the ground network access points 7 and the locations of the mobile core networks 9 of the back-end is disconnected, the adaptive satellite routing orchestration system selects to guide the traffic back to the low earth orbit satellite access points 24 so that the traffic is transmitted to the low earth orbit satellite networks (such as the low earth orbit satellites 22, the low earth orbit satellite network portal 23, etc.) via the low earth orbit satellite access points 24. Then, the traffic is transmitted from the low earth orbit satellite networks to a low earth orbit satellite ground user terminal 25 for traffic reception and traffic transmission (where the low earth orbit satellite ground user terminal 25 is switched from the submarine cable (undersea cable)), and finally the traffic is transmitted to the mobile core networks 9 of the back-end from the low earth orbit satellite ground user terminal 25. In this example, because the connection status of the submarine cable (undersea cable) is abnormal, the low earth orbit satellite network system 2 is used for traffic transmission to achieve backup purposes.

In summary, the adaptive satellite routing orchestration system is mainly responsible for analyzing the source terminal information of satellite incoming traffic, and for determining the backhaul routing (the communication backhaul network routing) based on the connection status of the submarine cable (undersea cable) so as to guide the traffic back to the mobile core networks. Furthermore, the adaptive satellite routing orchestration system completes a connection establishment process with the external network, and will analyze the source terminal information traffic inputted by the low earth orbit satellite, and will determine whether the source of the terminal information traffic is Wi-Fi or mobile network. When the source terminal information traffic is Wi-Fi, the routing switch control module guides the traffic to the Internet. When the source terminal information traffic is a mobile network, the routing switch control module guides the traffic to the mobile core network at the destination via the submarine cable (undersea cable) or the low earth orbit satellite networks. Specifically, if the source terminal information traffic is a mobile network and the traffic route is a low earth orbit satellite network, since the virtual channel established by the source end has been deactivated when the traffic enters the packet analysis module, this traffic requires high security level encryption to protect data integrity. Therefore, the packet analysis module will establish a new virtual channel for encryption and then will transmit the traffic to the low earth orbit satellite network. According to the above, the present disclosure can adaptively guide traffic to the Internet or the mobile core network.

Each module of the present disclosure can be software, hardware, or firmware; if the module is hardware, it can be a processing unit, processor, computer, or server with data processing and computing capabilities; if the module is software or firmware, it may include instructions executable by a processing unit, processor, computer, or server, and may be installed on the same hardware device or distributed on multiple different hardware devices.

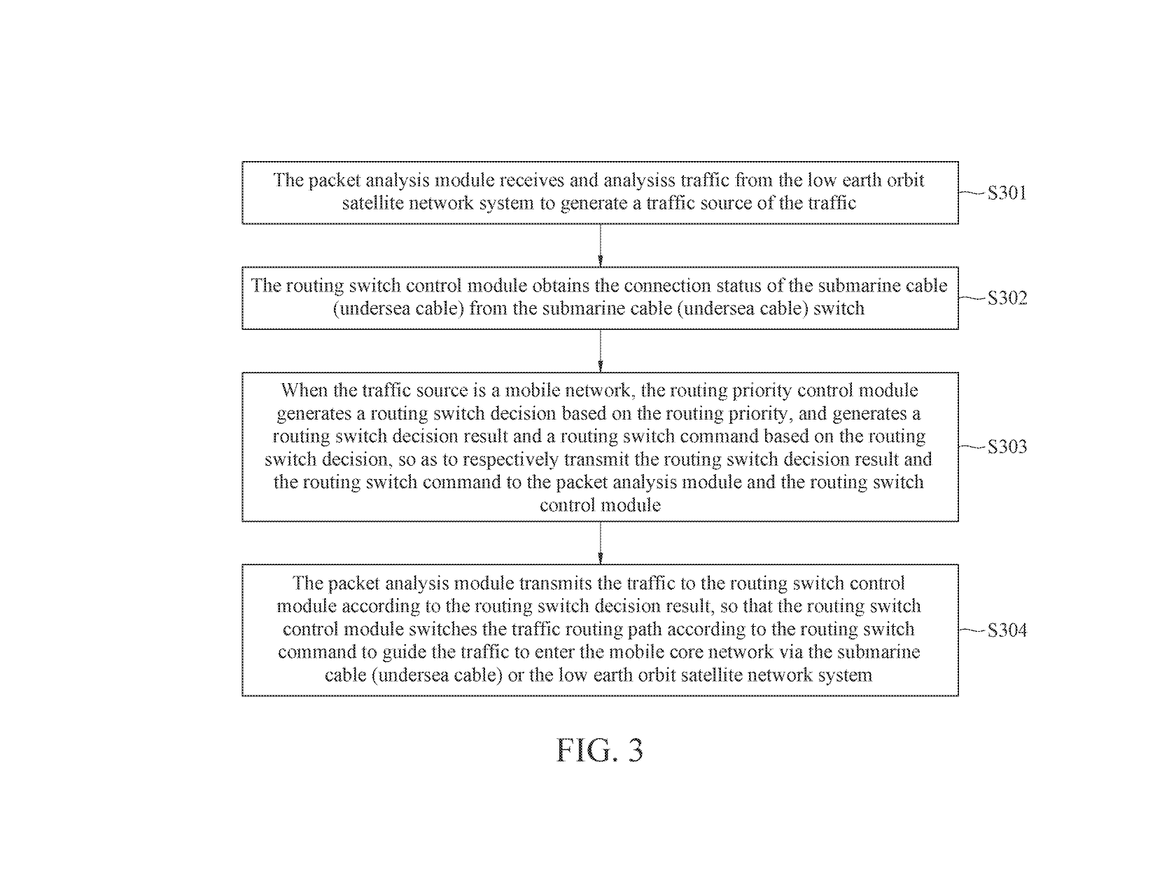

FIG. 3 is a step diagram of an adaptive satellite routing orchestration method according to the present disclosure. As shown in the figure, the adaptive satellite routing orchestration method of the present disclosure can be executed on a computer or a server. The purpose is to take the source of the traffic and the connection status of the submarine cable (undersea cable) into consideration so as to determine how the traffic should be transmitted.

In step S301, the packet analysis module receives and analyzes traffic from the low earth orbit satellite network system to generate a traffic source of the traffic. This step is to confirm the source of the traffic in order to provide different transmission methods according to different types. Therefore, the packet analysis module analyzes the traffic from the low earth orbit satellite network system to obtain the traffic source of the traffic.

In step S302, the routing switch control module obtains the connection status of the submarine cable (undersea cable) from the submarine cable switch. This step is based on the basis that when the traffic is a mobile network, the traffic must be transmitted by the submarine cable (undersea cable). Therefore, it is necessary to first confirm whether the submarine cable (undersea cable) is normal, so the routing switch control module will obtain the connection status of the subsequent submarine cable (undersea cable) connected to the mobile core network from the submarine cable (undersea cable) switch.

In step S303, when the traffic source is a mobile network, the routing priority control module generates a routing switch decision based on the routing priority, and generates a routing switch decision result and a routing switch command based on the routing switch decision, so as to respectively transmit the routing switch decision result and the routing switch command to the packet analysis module and the routing switch control module. This step is to determine the routing path when the traffic source is the mobile network and the connection status of the submarine cable (undersea cable) is considered. That is, the routing priority control module generates the routing switch decision based on the above factors, and generates the routing switch decision result and the routing switch command based on the routing switch decision, and provides the routing switch decision result and the routing switch command to the packet analysis module and the routing switch control module respectively, so that the packet analysis module and the routing switch control module perform subsequent packet delivery and route switching.

In one embodiment, the routing priority is generated by the routing priority control module based on the connection status of the submarine cable (undersea cable) obtained by the routing switch control module, wherein the routing priority may include transmission via the submarine cable (undersea cable) and transmission via the low earth orbit satellite network system.

In step S304, the packet analysis module transmits the traffic to the routing switch control module according to the routing switch decision result, so that the routing switch control module switches the traffic routing path according to the routing switch command so as to guide the traffic to enter the mobile core network via the submarine cable (undersea cable) or the low earth orbit satellite network system. This step further explains the subsequent processing of step S303, that is, the packet analysis module transmits the traffic to the routing switch control module based on the routing switch decision result, and the routing switch control module switches the routing path of the traffic according to the routing switch command. Finally, the traffic is guided to the mobile core network via the submarine cable (undersea cable) or the low earth orbit satellite network system.

In one embodiment, in step S301, if the packet analysis module analyzes and determines that the traffic source of the traffic is a wireless local area network, the packet analysis module directly transmits the traffic to the routing switch control module to guide the traffic into the Internet.

In one embodiment, when the packet analysis module analyzes and determines that the traffic source is a mobile network, it indicates that there is no need to use the virtual channel established by the source end of the traffic, and therefore the virtual channel is deactivated.

In addition, the steps for the routing switch control module to guide traffic into the mobile core network via the low earth orbit satellite network system specifically includes: establishing a new virtual channel and guiding the traffic to the private network by the packet analysis module; guiding the traffic to the low earth orbit satellite access point of the low earth orbit satellite network system via the new virtual channel by the routing switch control module; transmitting the traffic to the low earth orbit satellite ground terminal of the low earth orbit satellite network system via the low earth orbit satellite network; deactivating the new virtual channel; and the traffic entering the mobile core network.

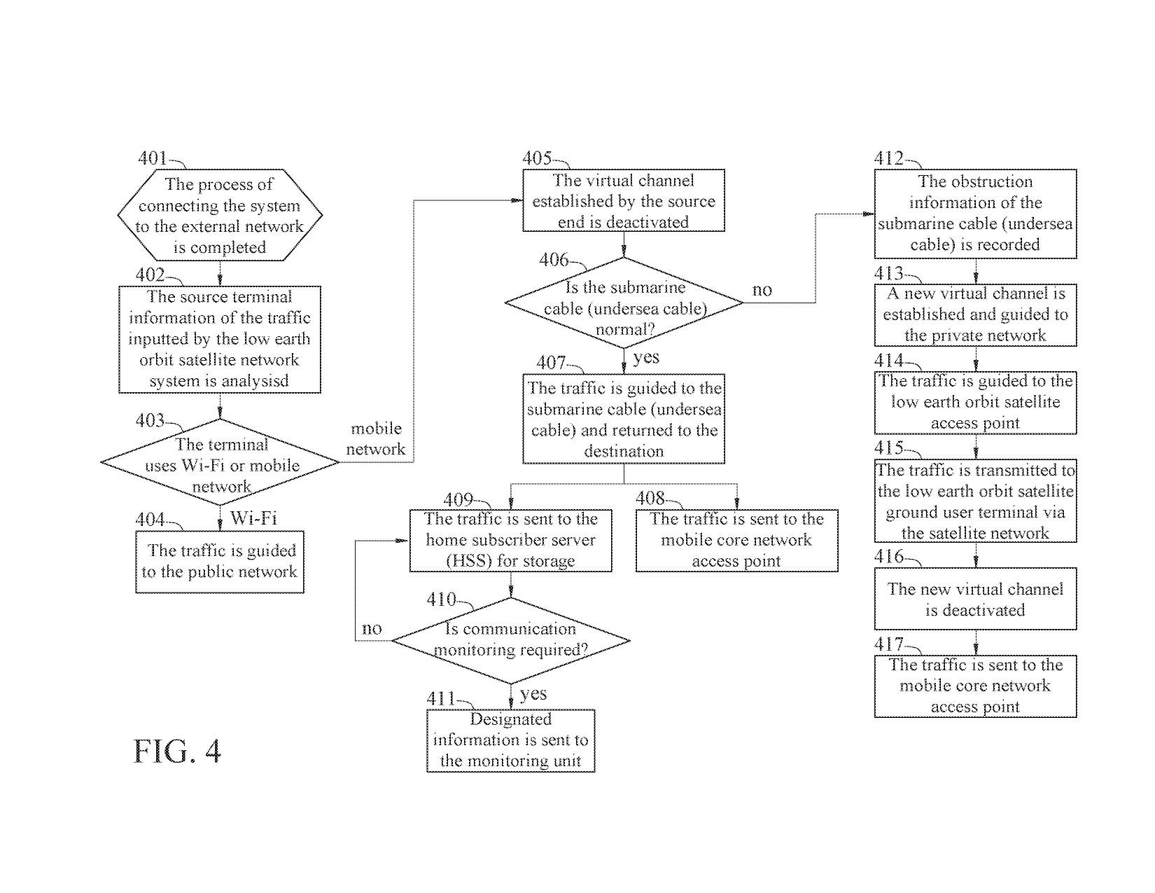

FIG. 4 is an operation flowchart of the adaptive satellite routing orchestration method according to the present disclosure.

In process 401, the process of connecting the system to the external network is completed. This process explains that the adaptive satellite routing orchestration system will set up the connection with the external network to complete the network communication mechanism between them.

In process 402, the source terminal information of the traffic inputted by the low earth orbit satellite network system is analyzed. This process explains that the adaptive satellite routing orchestration system will analyze the traffic from the low earth orbit satellite network system. This traffic is transmitted from the user terminal device, and the source of the traffic will be analyzed.

In process 403, the terminal uses Wi-Fi or mobile network. This process illustrates that the adaptive satellite routing orchestration system determines the source of the traffic. When the source is Wi-Fi, the operation proceeds to process 404. If the source is a mobile network, the operation proceeds to process 405.

In process 404, the traffic is guided to the public network. This process explains that because the traffic is transmitted via the wireless local area network (Wi-Fi) and does not pass through the base station, the traffic can be guided to the public network, that is, transmitted to the Internet.

In process 405, the virtual channel established by the source end is deactivated. This process explains that if the traffic is transmitted via the mobile network, the traffic needs to be sent to the mobile core network on the ground network end for confirmation before it can enter the Internet. Therefore, the traffic will enter the mobile core network on the ground network end via the submarine cable (undersea cable). At this time, transmission will not be carried out via the virtual channel established by the source end, so the virtual channel established by the source end can be deactivated.

In process 406, whether the submarine cable (undersea cable) is normal or not is checked. This process explains that the adaptive satellite routing orchestration system will obtain the connection status of the submarine cable (undersea cable) to check whether the submarine cable (undersea cable) is normal. If the submarine cable (undersea cable) is normal (yes), the operation proceeds to process 407; and if the submarine cable (undersea cable) is not normal (no), the operation proceeds to process 412.

In process 407, the traffic is guided to the submarine cable (undersea cable) and returned to the destination. This process explains that since the submarine cable (undersea cable) is operating normally, the submarine cable (undersea cable) is continued to be used for transmission operation. Therefore, the adaptive satellite routing orchestration system transmits the traffic to the destination via the submarine cable(undersea cable) , that is, to the mobile core network on the ground network end, such as entering the mobile core network installed at the destination.

In process 408, the traffic is sent to the mobile core network access point. This process explains that the traffic will be sent to the mobile core network access point (PoP) and then will enter the mobile core network.

In process 409, the traffic is sent to the home subscriber server (HSS) for storage. This process illustrates that in addition to transmitting the traffic, the traffic can also be sent to the HSS for storage.

In process 410, communication monitoring is required. This process explains that whether the above communications need to be monitored is determined. If monitoring is not required, the operation returns to process 409 and performs storing. If monitoring is required, the operation proceeds to process 411.

In process 411, designated information is sent to the monitoring unit. This process explains that the traffic and other relevant information are sent to the monitoring unit.

In process 412, the obstruction information of the submarine cable (undersea cable) is recorded. This process explains that when the submarine cable (undersea cable) is abnormal or disconnected, an alternative route is required. At this time, the obstruction of the submarine cable (undersea cable) will be recorded at the same time for subsequent reference.

In process 413, a new virtual channel is established and guided to the private network. This process explains that due to an abnormality in the submarine cable (undersea cable), the traffic must be transmitted via other routes. Therefore, a new virtual channel is established and belongs to the private network, so packet encryption must be performed.

In process 414, the traffic is guided to the low earth orbit satellite access point. This process explains that the traffic enters the low earth orbit satellite network system from the low earth orbit satellite access point, and the low earth orbit satellite network system is used as the routing path for traffic transmission.

In process 415, the traffic is transmitted to the low earth orbit satellite ground user terminal via the satellite network. This process explains that the traffic is transmitted to the target satellite receiving terminal via the low earth orbit satellite network within the low earth orbit satellite network system (such as the low earth orbit satellites, the low earth orbit satellite network portal, etc.), wherein the target satellite receiving terminal is set up in advance and is intended to be used for backup purposes.

In process 416, the new virtual channel is deactivated. This process explains that after the transmission of the traffic is completed in the low earth orbit satellite network, the new virtual channel previously established can be deactivated.

In process 417, the traffic is sent to the mobile core network access point. This process explains that the traffic is transmitted from the target satellite receiving terminal to the mobile core network access point, and finally the traffic enters the mobile core network.

It can be seen from the above that, before switching, the adaptive satellite routing orchestration system of the present disclosure will first confirm the connection status of the submarine cable (undersea cable) between the ground network access point (PoP) and the mobile core network at the back-end of the mobile network, and then will perform five major procedures.

First, the traffic type of the source terminal information is analyzed and confirmed. In other words, the adaptive satellite routing orchestration system first completes the connection process with the external network. The connection process with the external network includes external connections to the low earth orbit satellite network and the submarine cable (undersea cable). The adaptive satellite routing orchestration system will real-time analyze the traffic inputted from the satellite to the ground network access point, and will analyze that the traffic type of the source terminal is Wi-Fi traffic or mobile network traffic.

Second, routing decisions belong to the Wi-Fi traffic type. Specifically, after analysis by the adaptive satellite routing orchestration system, if the traffic type of the source terminal is Wi-Fi traffic, the adaptive satellite routing orchestration system will guide this traffic to the Internet.

Third, the connection status of the submarine cable (undersea cable) is monitored. In other words, the adaptive satellite routing orchestration system will real-time monitor the connection status of the submarine cable (undersea cable) to perform different path routing switches.

Fourth, the routing decision belongs to the mobile network traffic type and the connection status of the submarine cable (undersea cable) is normal. Specifically, when the connection status of the submarine cable (undersea cable) is normal and the traffic type of the source terminal is mobile network traffic, the adaptive satellite routing orchestration system will deactivate the virtual channel established by the source end and will guide the traffic to the submarine cable (undersea cable), so that the traffic can be transmitted back to the mobile core network access point of the destination via the submarine cable (undersea cable), and the traffic will be sent to the HSS for storage for communication monitoring purposes by the monitoring unit.

Fifth, the routing decision belongs to the mobile network traffic type and the connection status of the submarine cable (undersea cable) is abnormal. Specifically, when the connection status of the submarine cable (undersea cable) is abnormal or disconnected, the adaptive satellite routing orchestration system records the obstruction information of the submarine cable (undersea cable), and the adaptive satellite routing orchestration system analyzes and determines that the traffic type of the source terminal is mobile network traffic. The adaptive satellite routing orchestration system will deactivate the virtual channel established by the source end and will establish a new virtual channel and guide the traffic to the low earth orbit satellite network, so that the traffic can be transmitted back via the low earth orbit satellite network to the low earth orbit satellite ground user terminal (where the low earth orbit satellite ground user terminal is switched from the submarine cable (undersea cable) and is used for receiving and transmitting traffic) so as to be transmitted to the mobile core network.

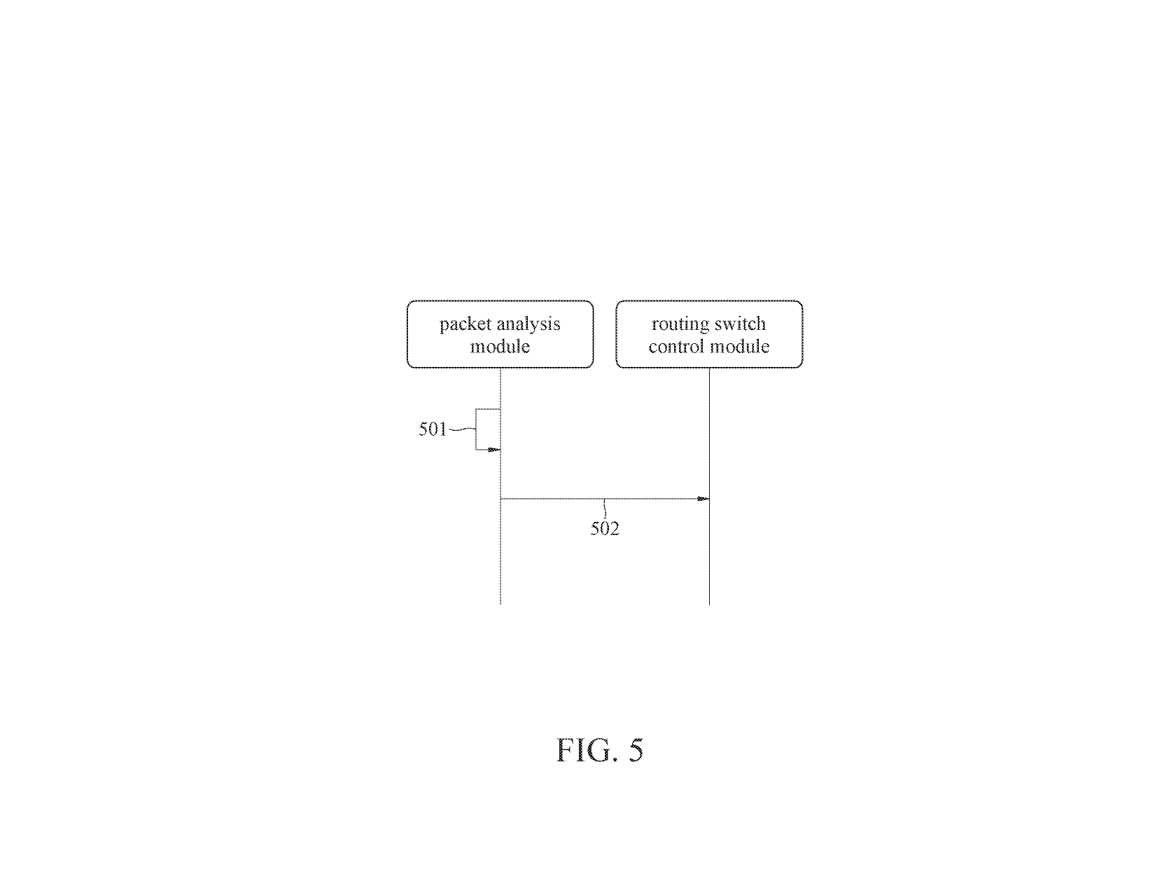

FIG. 5 is a time sequence diagram of Wi-Fi traffic signaling exchange according to the present disclosure. As shown in the figure, at time sequence 501, the packet analysis module analyzes the received traffic packet. If the packet analysis module analyzes and determines that the source end of the traffic packet is from Wi-Fi, then at time sequence 502, the packet analysis module will send the traffic to the routing switch control module, and the routing switch control module will guide the traffic to the Internet.

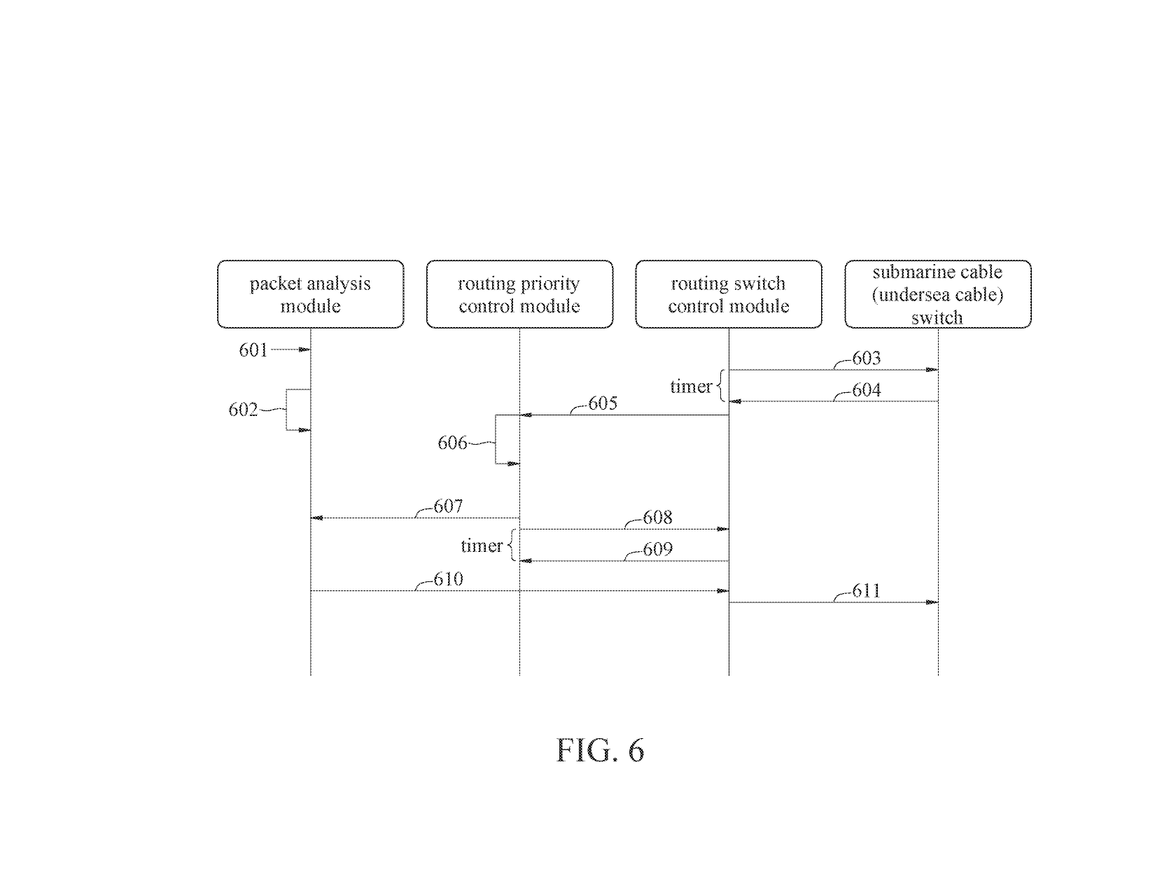

FIG. 6 is a time sequence diagram of the present disclosure regarding the exchange of the traffic signaling of the mobile network via a submarine cable (undersea cable). At time sequence 601 and time sequence 602, after receiving the traffic from the low earth orbit satellite network, the packet analysis module analyzes and determines that the source of the traffic is the mobile network.

At time sequence 603 and time sequence 604, the routing switch control module sends a request to the submarine cable (undersea cable) switch, that is, to inquire about the connection status of the submarine cable (undersea cable). Afterwards, the submarine cable (undersea cable) switch will give a report to the switching control module, wherein the above reporting process can be controlled by a timer on the routing switch control module side. That is, only those who report within a predetermined time will be accepted. On the contrary, if the predetermined time is exceeded, the routing switch control module re-submits the request. In addition, the connection status of the submarine cable (undersea cable) obtained in this embodiment is normal.

At time sequence 605 and time sequence 606, the routing switch control module returns the inquired connection status of the submarine cable (undersea cable) to the routing priority control module. The routing priority control module will decide the routing priority based on the traffic source analyzed and generated by the packet analysis module and the connection status of the submarine cable (undersea cable). That is, a routing switch decision is generated based on the routing priority level, and this routing switch decision will generate a routing switch decision result and a routing switch command.

At time sequence 607, the routing priority control module returns the routing switch decision result to the packet analysis module, informing the packet analysis module that subsequent traffic is transmitted via the submarine cable (undersea cable).

At time sequence 608 and time sequence 609, the routing priority control module returns a routing switch command to the routing switch control module. After the route switching, the routing switch control module returns a routing switch complete message to the routing priority control module. Similarly, the above-mentioned round-trip process can be controlled by a timer on the routing priority control module side to ensure that the route switching is indeed completed.

At time sequence 610, the packet analysis module transmits the traffic to the routing switch control module, so that the routing switch control module transmits the traffic according to the route after the switching is completed.

At time sequence 611, the routing switch control module transmits the traffic to the submarine cable (undersea cable) switch, so that the traffic is transmitted to the mobile core network of the back-end via the submarine cable (undersea cable).

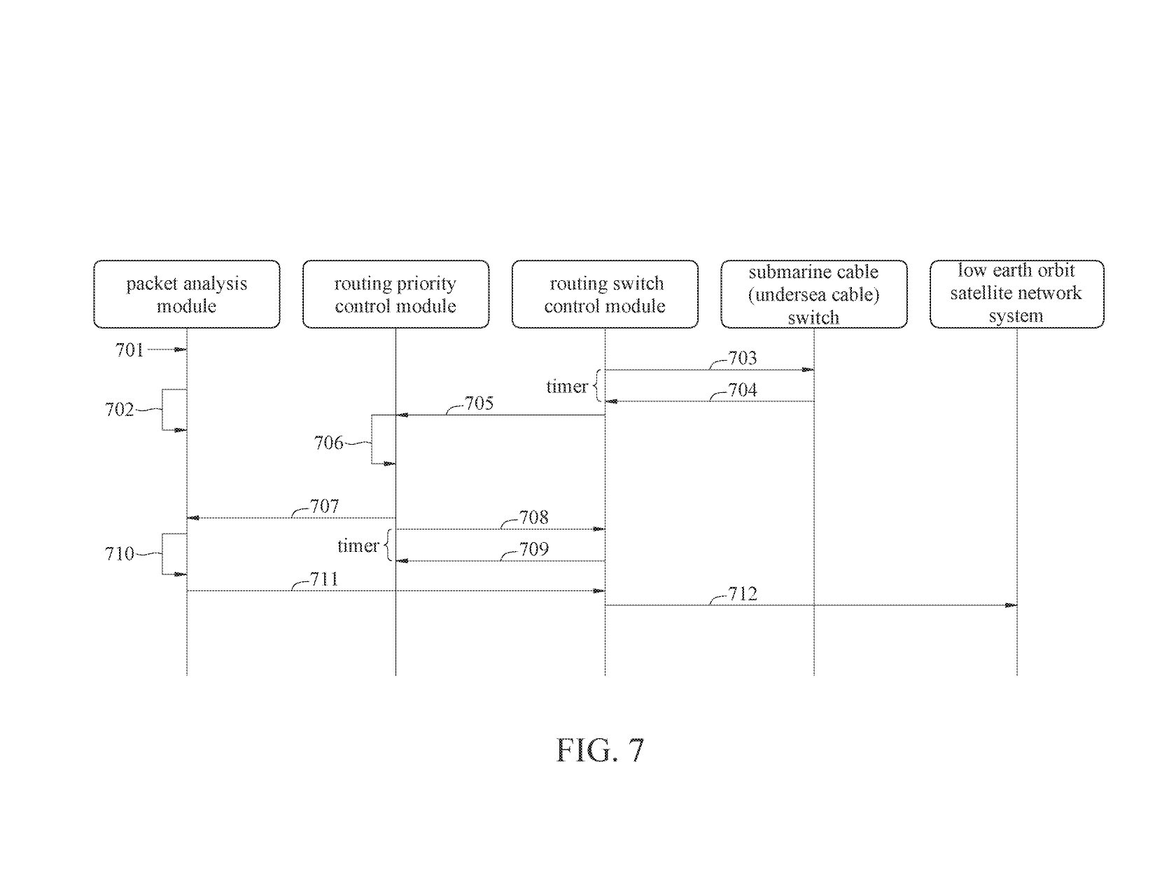

FIG. 7 is a time sequence diagram of the present disclosure regarding the exchange of the traffic signaling of the mobile network via a low earth orbit satellite network system.

At time sequence 701 and time sequence 702, after receiving the traffic from the low earth orbit satellite network, the packet analysis module analyzes and determines that the source of the traffic is the mobile network.

At time sequence 703 and time sequence 704, the routing switch control module sends a request to the submarine cable (undersea cable) switch, that is, to inquire about the connection status of the submarine cable (undersea cable). Afterwards, the submarine cable (undersea cable) switch will give a report to the switching control module, wherein the above-mentioned round-trip process can be controlled via a timer to prevent the report from exceeding the time limit. The connection status of the submarine cable (undersea cable) obtained in this embodiment is abnormal.

At time sequence 705 and time sequence 706, the routing switch control module returns the inquired connection status of the submarine cable (undersea cable) to the routing priority control module. The routing priority control module will make a routing decision based on the traffic source analyzed by the packet analysis module and the connection status of the submarine cable (undersea cable) so as to generate a routing switch decision, and the routing switch decision will generate a routing switch decision result and a routing switch command.

At time sequence 707, the routing priority control module returns the routing switch decision result to the packet analysis module, informing the packet analysis module that subsequent traffic cannot be transmitted via the submarine cable (undersea cable) and the routing path must be switched to the low earth orbit satellite network.

At time sequence 708 and time sequence 709, the routing priority control module returns a routing switch command to the routing switch control module. After the route switching, the routing switch control module returns a routing switch complete message to the routing priority control module. Similarly, the above-mentioned round-trip process can be controlled by a timer on the routing priority control module side to ensure that the route switching is indeed completed.

At time sequence 710, because the traffic is decided not to go through the submarine cable (undersea cable) but to be transmitted by the low earth orbit satellite network system, the packet analysis module establishes a new virtual channel.

At time sequence 711, the packet analysis module transmits the traffic to the routing switch control module, so that the routing switch control module transmits the traffic according to the route after the switching is completed.

At time sequence 712, the routing switch control module transmits the traffic to the low earth orbit satellite network system, so that the traffic is transmitted to the mobile core network of the back-end via the low earth orbit satellite network.

In addition, the present disclosure also discloses a computer-readable medium, which is applied to a computing device or computer having a processor (for example, central processing unit [CPU], graphics processing unit [GPU], etc.) and/or a memory, and stores instructions. Moreover, the computing device or computer can be used to execute the computer-readable medium via the processor and/or memory, so as to execute the above-mentioned method and each step process when executing the computer-readable medium. In one embodiment, the computer-readable medium is a non-transitory computer-readable storage medium.

In summary, the adaptive satellite routing orchestration system, method and computer-readable medium thereof of the present disclosure provide a low earth orbit satellite network architecture. Under the low earth orbit satellite network architecture, by the determination of the connection status of the external submarine cable (undersea cable) at the location where the ground network access point and the mobile core network are connected to the mobile network, the traffic of the mobile network is guided to the mobile core network via the submarine cable (undersea cable) or the traffic of the mobile network is guided to the low earth orbit satellite access point (PoP), so that the traffic can be transmitted to the low earth orbit satellite network via the low earth orbit satellite access point, and then the traffic is transmitted via the low earth orbit satellite network to the low earth orbit satellite ground user terminal (where the low earth orbit satellite ground user terminal is switched from the submarine cable (undersea cable) and is used for receiving and transmitting traffic) so as to be transmitted to the mobile core network.

The above detailed description is a specific description of a feasible embodiment of the present disclosure. However, this embodiment is not intended to limit the patent scope of the present disclosure. Any equivalent implementation or modification that does not depart from the technical spirit of the present disclosure shall be included in the patent scope of the present disclosure.

What is claimed is:

1. An adaptive satellite routing orchestration system, comprising:
a packet analysis module configured for receiving traffic from a low earth orbit satellite network system to analyze the traffic to generate a traffic source of the traffic;
a routing switch control module connected to a submarine cable switch and configured for obtaining a submarine cable connection status from the submarine cable switch; and
a routing priority control module connected to the packet analysis module and the routing switch control module, and configured for generating a routing switch decision based on a routing priority when the traffic source is a mobile network, wherein a routing switch decision result and a routing switch command are generated based on the routing switch decision, and the routing switch decision result and the routing switch command are transmitted to the packet analysis module and the routing switch control module respectively,
wherein the packet analysis module sends the traffic to the routing switch control module according to the routing switch decision result, so that the routing switch control module switches a traffic routing path according to the routing switch command to guide the traffic to enter a mobile core network via a submarine cable or the low earth orbit satellite network system.

2. The adaptive satellite routing orchestration system of claim 1, wherein the packet analysis module directly transmits the traffic to the routing switch control module to guide the traffic into the Internet when the packet analysis module analyzes and determines that the traffic source of the traffic is a wireless local area network.

3. The adaptive satellite routing orchestration system of claim 1, wherein the routing priority is generated by the routing priority control module based on the submarine cable connection status obtained by the routing switch control module, wherein the routing priority includes transmission via the submarine cable and transmission via the low earth orbit satellite network system.

4. The adaptive satellite routing orchestration system of claim 1, wherein a virtual channel established by a source end of the traffic is deactivated when the packet analysis module analyzes and determines that the traffic source is a mobile network.

5. The adaptive satellite routing orchestration system of claim 1, wherein when the traffic enters the mobile core network via the low earth orbit satellite network system, a new virtual channel is first established by the packet analysis module and guided to a private network, so that the routing switch control module guides the traffic to a low earth orbit satellite access point of the low earth orbit satellite network system via the new virtual channel, and after the traffic is transmitted to a low earth orbit satellite ground terminal of the low earth orbit satellite network system via the low earth orbit satellite network, the new virtual channel is deactivated, and finally the traffic enters the mobile core network.

6. An adaptive satellite routing orchestration method, comprising:
receiving, by a packet analysis module, traffic from a low earth orbit satellite network system to analyze the traffic to generate a traffic source of the traffic;
obtaining, by a routing switch control module, a submarine cable connection status from a submarine cable switch;
generating, by a routing priority control module, a routing switch decision based on a routing priority when the traffic source is a mobile network, wherein a routing switch decision result and a routing switch command are generated based on the routing switch decision, and the routing switch decision result and the routing switch command are transmitted to the packet analysis module and the routing switch control module respectively; and
sending, by the packet analysis module, the traffic to the routing switch control module according to the routing switch decision result, so that the routing switch control module switches a traffic routing path according to the routing switch command to guide the traffic to enter a mobile core network via a submarine cable or the low earth orbit satellite network system.

7. The adaptive satellite routing orchestration method of claim 6, wherein the packet analysis module directly transmits the traffic to the routing switch control module to guide the traffic into the Internet when the packet analysis module analyzes and determines that the traffic source of the traffic is a wireless local area network.

8. The adaptive satellite routing orchestration method of claim 6, wherein the routing priority is generated by the routing priority control module based on the submarine cable connection status obtained by the routing switch control module, wherein the routing priority includes transmission via the submarine cable and transmission via the low earth orbit satellite network system.

9. The adaptive satellite routing orchestration method of claim 6, wherein a virtual channel established by a source end of the traffic is deactivated when the packet analysis module analyzes and determines that the traffic source is a mobile network.

10. The adaptive satellite routing orchestration method of claim 6, wherein the step of the routing switch control module guiding the traffic to the mobile core network via the low earth orbit satellite network system comprises: a new virtual channel is first established by the packet analysis module and guided to a private network, so that the routing switch control module guides the traffic to a low earth orbit satellite access point of the low earth orbit satellite network system via the new virtual channel, and after the traffic is transmitted to a low earth orbit satellite ground terminal of the low earth orbit satellite network system via the low earth orbit satellite network, the new virtual channel is deactivated, and finally the traffic enters the mobile core network.

11. A computer-readable medium, used in a computing device or a computer, which stores instructions to execute the adaptive satellite routing orchestration method of claim 6.
